(19) United States
(12) Patent Application Publication
(10) Pub. No.: US 2008/0064407 A1
(43) Pub. Date: Mar. 13, 2008

(54) Congestion arbitration for a wireless network

(76) Inventor: Scott Miller, Santa Barbara, CA (US)

Correspondence Address: MARK RODGERS, 1590 SAN ROQUE ROAD, SANTA BARBARA, CA, 93105, US

(21) Appl. No.: 11/521,280

(22) Filed: Sep. 13, 2006

(51) Int. Cl. H04Q 7/20

(52) U.S. Cl. 455/442

(57) ABSTRACT

The invention is a congestion arbitration function, and method of using, for a wireless network. A suitable wireless network will have at least one gateway to the internet or other outside network, and a plurality of dispersed nodes which communicate with each other and through the gateway to the outside. Each dispersed node, upon wake-up, or other need to communicate with the gateway, transmits a short communication request, either directly to the gateway from an inner node, or relayed through an inner node from an outer node. The gateway assigns a communication network grant in response to each request, thereby eliminating congestion. Each node will retry sending the request until it is acknowledged, assuring that data is not lost.

### RELATED APPLICATIONS

Not Applicable

### FEDERALLY SPONSORED RESEARCH

Not Applicable

### SEQUENCE LISTING

Not Applicable

### BACKGROUND OF THE INVENTION

The invention relates to wireless networks, and in particular networks that consist of dispersed nodes which communicate outside of the network through a gateway. The gateway is also the coordinator of the dispersed wireless network.

A rapidly growing class of wireless networks consist of a number of network nodes, dispersed over an area, where each node is a small, independent device capable of performing a task. Such tasks may include monitoring sensors which measure some parameter of the environment local to or connected to the node. Examples include nodes which monitor environmental parameters such as light intensity, temperature, humidity; industrial parameters for assembly lines, cleanrooms, power stations and the like; or even home parameters such as leaks or motion detection.

A convenient implementation of such networks is for the nodes to consist of compact, typically battery powered, devices which include processing capability, sensors and sensor interfaces, and wireless communication capability. Examples of such devices are manufactured by AccSense Inc., the assignee of this application. The advantage of such devices is that they are versatile and may be placed and used in a variety of both outdoor and indoor environments. However each individual node, to conserve power, typically has limited communication range.

FIG. 1 illustrates a typical arrangement of such a network. Usually the network includes a gateway device, 1. The gateway can be larger, and consume more power, since it can be placed in any convenient location without the necessity to sense or physically connect to the environment. The gateway performs the function of connecting network nodes to the world outside the network 2, typically the internet and, as mentioned above, is the coordinator of the wireless network. The network nodes therefore must communicate with the gateway in order to receive instructions from and send data to the outside world.

As shown in FIG. 1 the nodes are dispersed. Nodes 3 are close enough to the gateway 1 to communicate directly. Outer modes 4 may be too far away from the gateway 1 to communicate directly, but close enough to inner nodes 3 to communicate with the gateway 1 by having communications relayed through the inner nodes 3. A common problem which can occur is that several of the nodes may need to communicate simultaneously. Inner nodes 3 are usually relatively simple devices and can easily become overloaded if too many outer nodes are attempting communication at the same time. Thus network congestion can occur. Additionally, it is important that all of the nodes wake up at the same time so that the inner nodes are able relay messages from the outer nodes and so that data measurements are taken by all of the nodes at approximately the same time.

Congestion is known in the wireless network field. For example IEEE Standard 802.15.4 has limited congestion handling. In networks following this standard, a node desiring access to the network for the purpose of sending data listens for traffic on its configured frequency indicating another node is communicating. If the node determines that there is traffic on its configured frequency, it waits for a random amount of time before checking again and, if it determines that there is no traffic on its frequency, it will send its data. However, the standard only supports a limited number or retries before the node stops attempting to send. Thus data can be lost or delayed. In communications protocols such as TCP/IP, such delays are acceptable since packets are sent redundantly, and the receiver continues to request the information until an entire data set is received. Another problem that occurs in wireless networks utilizing IEEE Standard 802.15.4 is one of collision detection. For example, if 2 nodes attempt to send their data simultaneously after checking their frequency, there is a chance that they may both transmit on the wireless media simultaneously, resulting in lost data. Therefore, in a network of sensor nodes operating independently from the outside world, and utilizing lower level protocols, congestion and collisions, even with existing arbitration schemes will result in lost data. Therefore, it is the object of this invention to reduce the effect of congestion and collisions by providing a unique arbitration algorithm suitable to dispersed network nodes communicating to the Internet or other network through a gateway with the aim of utilizing the wireless network's bandwidth more efficiently. This arbitration algorithm will allow the nodes to send their data more quickly and allow the nodes to conserve battery power.

### BRIEF SUMMARY OF THE INVENTION

Therefore, the invention is, in one embodiment, a wireless network arbitration function for a network, which includes at least one gateway node and a plurality of dispersed nodes. The function includes a gateway application which listens for communication requests from the dispersed nodes, and permits, or “grants” the network to each node in response to the request. The function also includes a dispersed node application, which upon waking up or needing to communicate with the gateway, sends a short communication request to the gateway requesting access to the network, and waits until the gateway grants the network to the node.

In a preferred embodiment the dispersed node application further includes that an inner node within range of the gateway will relay communication requests and network grants between the gateway and an outer node out of range of the gateway, but within the range of the inner node. Preferably for both the relayed and direct requests, dispersed nodes will retry sending any request until the gateway acknowledges the request or until an error timeout occurs.

In another embodiment, the invention is a method of arbitrating congestion on a wireless network utilizing the various capabilities of the novel function as described herein.

### BRIEF DESCRIPTION OF THE DRAWINGS

The invention will be better understood by referring to the following figures.

FIG. 1 illustrates a network of the type applicable to the invention.

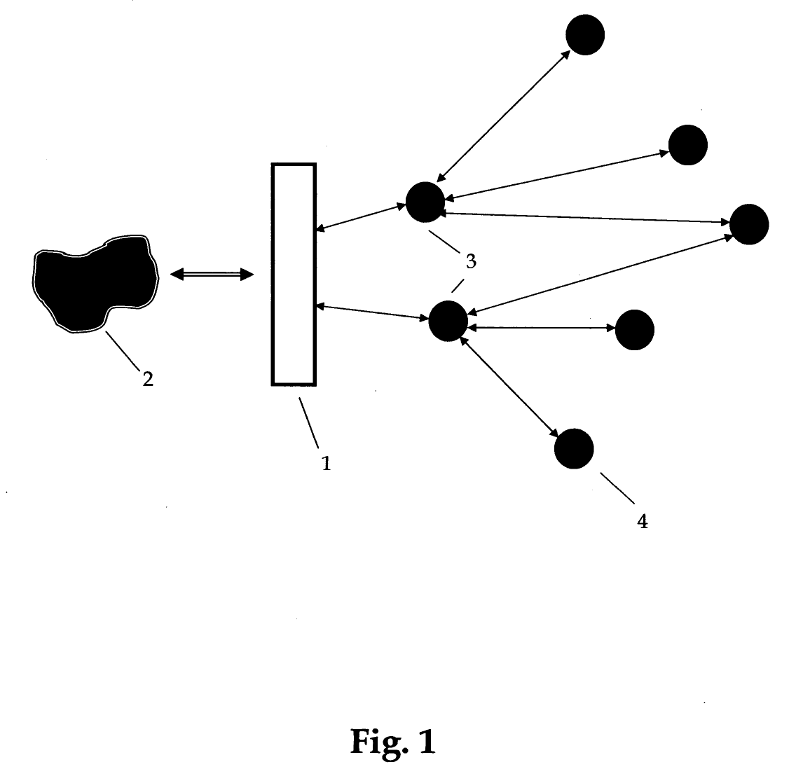

FIG. 2 is a flow chart of the invention for the gateway node.

FIG. 3 is a flow chart of the invention for a dispersed node.

### DETAILED DESCRIPTION OF THE INVENTION

The novel arbitration function is illustrated through a series of figures showing it's operation in nodes occupying various positions in the network. Each type of node obviously may perform a variety of operations, but only those pertinent to the function are shown.

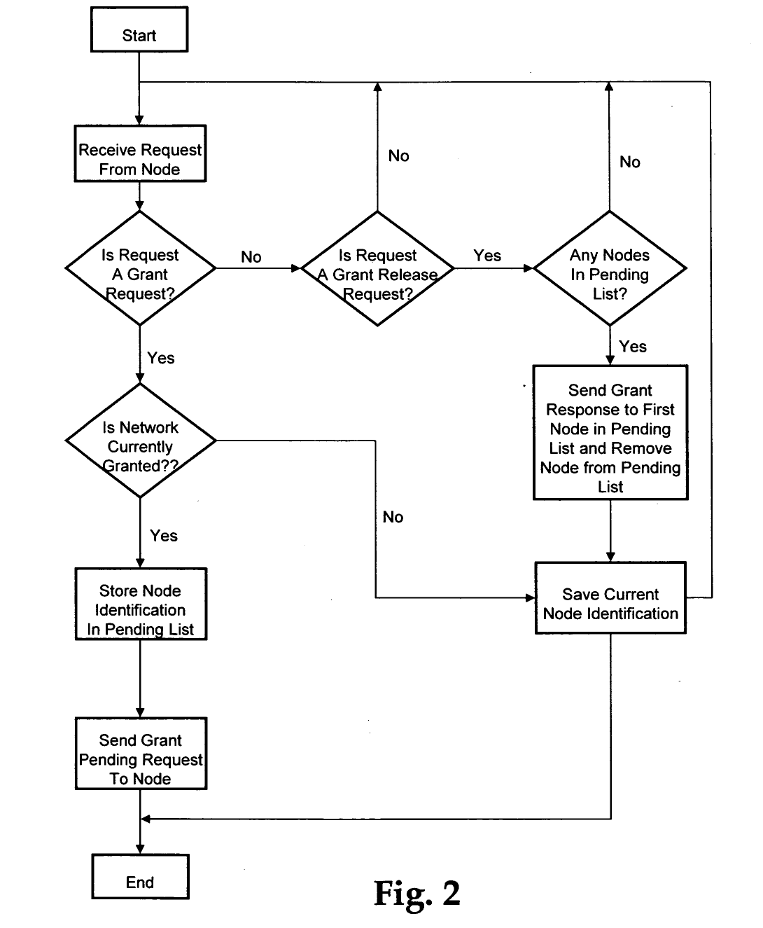

The gateway portion of the function is shown in FIG. 2. The gateway 1 listens for communication requests from the dispersed nodes. Upon receipt of a “grant request” from a dispersed node, the gateway shall issue a “grant response” if no other node has control of the network. The gateway keeps track of the node that has been granted the network in this case. However, if a “grant request” is received from a dispersed node and another node already has been granted the network, the gateway issues a “grant pending response” to that node. It then inserts this node's identity in a list of nodes that have been requested, but denied access to the network (network grant pending). Upon receipt of a “grant release request” from the dispersed node that has been granted the network, the gateway application selects one of the nodes in the “network grant pending” list and then sends a “grant response” to that node.

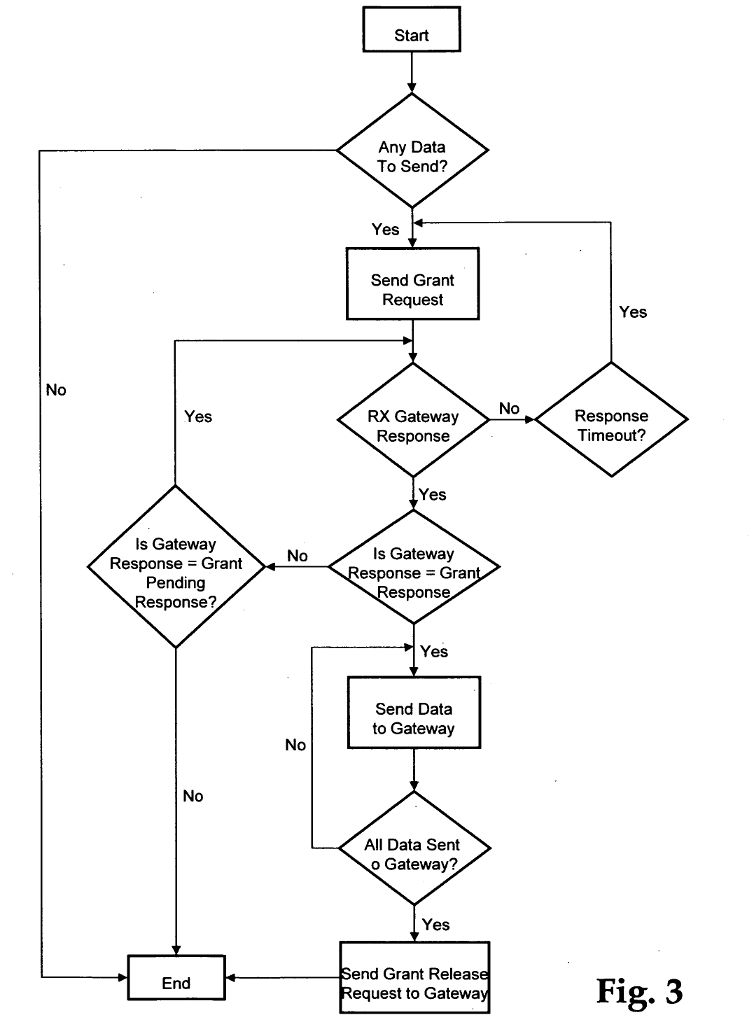

The dispersed node portion of the function is shown in FIG. 3. Upon determining that it must send data on its configured frequency, the node shall issue a “grant request” to the gateway. If the node receives a “grant response” from the gateway, it shall start sending its data to the gateway. However, if the node receives a “grant pending response”, it shall not send its data and wait for the gateway to issue a “grant response” to it. If, while waiting for the “grant response” after receiving the “grant pending response”, a timeout occurs, the node shall issue the “grant request” again. It will become evident that, because the gateway only allows one node at a time to send its data and because the network traffic due to nodes issuing “grant requests” is minimal, overall network efficiency is improved because network congestion is minimized.

Alternatively, the gateway could use a different frequency or even a different radio to alert the nodes that the network arbitration scheme is permitted to begin. Such a scheme is used to enhance node battery life. In co-pending application Ser. No. 11/319,860, owned by the same assignee as the current invention, a dual radio scheme is disclosed where one radio is particularly suited to the “alert” function and the other radio is suited for full communication. However, such a scheme is a special case of the invention. The invention is still operable with no data loss or congestion, but possibly with some delays, if only one communication channel exists.

Thus a novel network arbitration function, and method of operating same, has been disclosed. Alternative approaches will suggest themselves to one skilled in the art. The scope of the invention should only be determined by the following claims

I claim:

1. A wireless network arbitration function for a network, which includes at least one gateway node and a plurality of dispersed nodes, comprising:
a gateway application which listens for network grant communication requests from the dispersed nodes, and temporarily assigns, or grants, the network to each node in response to the request, and;
a dispersed node application, which upon waking up or needing to communicate with the gateway, sends a short communication request to the gateway, and upon receipt of the network grant, communicates its data to the gateway.

2. The function of claim 1 wherein the dispersed nodes will retry sending the timeslot request until the gateway acknowledges the request or until an error timeout occurs.

3. A method of arbitrating congestion for a wireless network, where the network includes at least one gateway node and a plurality of dispersed nodes, comprising:
listening by the gateway node for communication requests from the dispersed nodes,
assigning from the gateway node communication grants to each node in response to the request, and;
sending a short communication request from any one of the dispersed nodes upon the node waking up or needing to communicate with the gateway,
receiving the grant from the gateway node, and:
waiting to communicate until the gateway assigned grant occurs.
